(19) United States
(12) Patent Application Publication
(10) Pub. No.: US 2023/0054187 A1
(43) Pub. Date: Feb. 23, 2023

(54) METHODS AND APPARATUS FOR KEYWORD SEARCH TERM RECOMMENDATIONS FOR TAXONOMY ENRICHMENT

(71) Applicant: Walmart Apollo, LLC, Bentonville, AR (US)

(72) Inventors: Amlan Jyoti Das, West Bengal (IN); Abin Abraham, Bangalore (IN); Prashant Ravindra Singh, Dallas, TX (US); Srujana Kaddevarmuth, Cupertino, CA (US); Avanti Gaurav Shah, San Jose, CA (US)

(21) Appl. No.: 17/813,919

(22) Filed: Jul. 20, 2022

Related U.S. Application Data
(60) Provisional application No. 63/234,573, filed on Aug. 18, 2021.

(51) Int. Cl. G06Q 30/06; G06F 16/9535; G06F 16/906

(52) U.S. Cl. CPC G06Q 30/0631; G06F 16/9535; G06F 16/906

(57) ABSTRACT

A system can implement operations that generate a representative keyword search term based on obtained domain data. The operations including, based on the domain data, identifying keyword search term data, product data, and interaction data. Additionally, the operations include determining a set of keyword search term-product pairings, based on the keyword search term data, the product data and the interaction data. Moreover, the operations include determining, one or more clusters of keyword search terms and, a representative keyword search term for each of the one or more clusters of keyword search terms, based on an engagement score associated with each keyword search term and the set of keyword search terms. Furthermore, the operations include outputting the representative keyword search term of each of the one or more clusters of keyword search terms.

### CROSS-REFERENCE TO RELATED APPLICATIONS

This application claims the benefit of priority to U.S. Provisional Patent Application No. 63/234,573, filed on Aug. 18, 2021, the entire disclosure of which is expressly incorporated herein by reference to its entirety.

### TECHNICAL FIELD

The disclosure relates generally to apparatus and methods for keyword search term recommendations.

### BACKGROUND

At least some ecommerce platforms can include search engine systems that can enable customer to search for products. Generally, along with a good ontology definition, a well-organized and comprehensive taxonomy library or catalog of the search engine system can affect the relevance in an internal search and the level of traffic to the ecommerce platform from an external search engine. Additionally, the organization and comprehensiveness of the taxonomy library or catalog of the search engine system can affect the search-to-purchase conversion rate of a commerce platform (e.g., the rate at which users purchase items or products appearing in search results stemming from search queries requested by the users).

Conventionally, taxonomy libraries and catalogs are constructed and maintained manually by an operator, such as a website operator, of a particular e-commerce entity. For example, the taxonomy may be defined and maintained manually based on the operator's business knowledge, and the standard practices and vast product catalogue of the ecommerce entity. Such an approach can be extremely time consuming and slow to adapt to the gradual increase in the variety of products and changing demands of customers of the e-commerce entity.

### SUMMARY

The embodiments described herein are directed to the construction and maintenance of a taxonomy library or catalog of a search engine system of an ecommerce platform (e.g., the organization, definition and/or modification of taxonomy nodes or elements of the taxonomy library or catalog). In various implementations, the construction and maintenance of the taxonomy library can be optimized for particular user or customer interactions (e.g., add-to-cart interactions, click-through interactions, etc.) occurring between the customer and an ecommerce platform of an ecommerce entity, such as a web site. The apparatus and methods described herein may be data driven and applied to the construction and maintenance of new or existing search engines. In some instances, the apparatus and methods described herein may prevent an operator from spending months on building a customer friendly and search relevant taxonomy from scratch. Moreover, with the carefully chosen steps, the apparatus and methods may not require labeled training data and is not computational resource heavy. Additionally, the apparatus and methods described herein may be scalable to fit any website requirements of a variety of ecommerce entity sizes.

In accordance with various embodiments, exemplary computing systems may be implemented in any suitable hardware or hardware and software, such as in any suitable computing device. In some embodiments a system including one or more processors may be configured to obtain domain data. The domain data may indicate a first domain. Additionally, the system may, in response to and based on the obtained domain data, implement one or more keyword search recommendation operations. In some examples, the one or more keyword search recommendation operations includes, based on the first domain, identifying (i) keyword search term data associated with the first domain, (ii) product data associated with the first domain, and (iii) interaction data associated with the first domain. In some implementations, the keyword search term data may indicate a set of keyword search terms associated with the first domain. In other implementations, the product data may indicate one or more products one or more users engaged with via a user interface. In various implementations, the interaction data may indicate for each interaction, a particular interaction stemming from a keyword search term and a product that was included in a search results based on the keyword search term.

Additionally, the one or more keyword search recommendation operations may further include, based on the keyword search term data, the product data and the interaction data, determining a set of keyword search term-product pairings, and an engagement score associated with each keyword search term-product pairing of the set of keyword search term-product pairings. Moreover, the one or more keyword search recommendation operations may further include, based on the set of keyword search terms and the engagement score associated with each keyword search term-product pairing of the set of keyword search term-product pairings, determining, one or more clusters keyword search terms. In various implementations, each of the one or more clusters of keyword search terms includes one or more keyword search terms of the set of keyword search terms that are associated with a particular product of the one or more products. Furthermore, the one or more keyword search recommendation operations may also include, based on the engagement score associated with each keyword search term, determining, for each of the one or more clusters of keyword search terms, a representative keyword search term. That way, the system may be configured to output the representative keyword search term of each of the one or more clusters of keyword search terms.

In some embodiments, a method is provided that includes obtaining domain data. The domain data may indicate a first domain. Additionally, the method may include, in response to and based on the obtained domain data, implement one or more keyword search recommendation operations. In some examples, the one or more keyword search recommendation operations includes, based on the first domain, identifying (i) keyword search term data associated with the first domain, (ii) product data associated with the first domain, and (iii) interaction data associated with the first domain. In some implementations, the keyword search term data may indicate a set of keyword search terms associated with the first domain. In other implementations, the product data may indicate one or more products one or more users engaged with via a user interface. In various implementations, the interaction data may indicate for each interaction, a particular interaction stemming from a keyword search term and a product that was included in a search results based on the keyword search term.

Additionally, the one or more keyword search recommendation operations may further include, based on the keyword search term data, the product data and the interaction data, determining a set of keyword search term-product pairings, and an engagement score associated with each keyword search term-product pairing of the set of keyword search term-product pairings. Moreover, the one or more keyword search recommendation operations may further include, based on the set of keyword search terms and the engagement score associated with each keyword search term-product pairing of the set of keyword search term-product pairings, determining, one or more clusters keyword search terms. In various implementations, each of the one or more clusters of keyword search terms includes one or more keyword search terms of the set of keyword search terms that are associated with a particular product of the one or more products. Furthermore, the one or more keyword search recommendation operations may also include, based on the engagement score associated with each keyword search term, determining, for each of the one or more clusters of keyword search terms, a representative keyword search term, and outputting the representative keyword search term of each of the one or more clusters of keyword search terms.

In yet other embodiments, a non-transitory computer readable medium has instructions stored thereon, where the instructions, when executed by at least one or more processors, cause a system to obtain domain data. The domain data may indicate a first domain. Additionally, the system may, in response to and based on the obtained domain data, implement one or more keyword search recommendation operations. In some examples, the one or more keyword search recommendation operations includes, based on the first domain, identifying (i) keyword search term data associated with the first domain, (ii) product data associated with the first domain, and (iii) interaction data associated with the first domain. In some implementations, the keyword search term data may indicate a set of keyword search terms associated with the first domain. In other implementations, the product data may indicate one or more products one or more users engaged with via a user interface. In various implementations, the interaction data may indicate for each interaction, a particular interaction stemming from a keyword search term and a product that was included in a search results based on the keyword search term.

Additionally, the one or more keyword search recommendation operations may further include, based on the keyword search term data, the product data and the interaction data, determining a set of keyword search term-product pairings, and an engagement score associated with each keyword search term-product pairing of the set of keyword search term-product pairings. Moreover, the one or more keyword search recommendation operations may further include, based on the set of keyword search terms and the engagement score associated with each keyword search term-product pairing of the set of keyword search term-product pairings, determining, one or more clusters of keyword search terms. In various implementations, each of the one or more clusters of keyword search terms includes one or more keyword search terms of the set of keyword search terms that are associated with a particular product of the one or more products. Furthermore, the one or more keyword search recommendation operations may also include, based on the engagement score associated with each keyword search term, determining, for each of the one or more clusters of keyword search terms of, a representative keyword search term. That way, the system may output the representative keyword search term of each of the one or more clusters of keyword search terms.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an example search engine system that includes a recommender computing device;

FIG. 2 illustrates a block diagram of example recommender computing device of FIG. 1 in accordance with some embodiments;

FIG. 3 is a block diagram illustrating examples of various portions of the recommender computing device of FIG. 1 in accordance with some embodiments;

FIG. 4 illustrates an example Bipartite graph in accordance with some embodiments; and

FIG. 5 illustrates an example method that can be carried out by the recommender computing device of FIG. 1.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

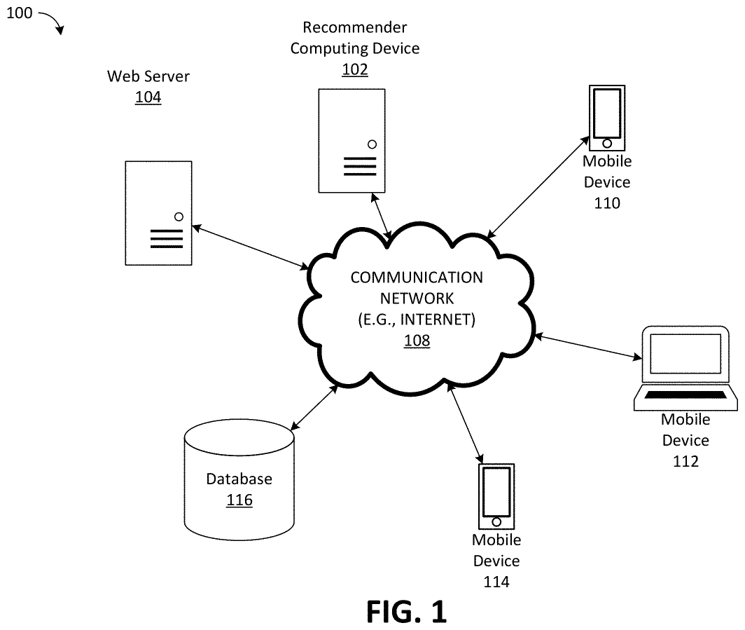

FIG. 1 illustrates a block diagram of an example search engine system 100 that includes a recommender computing device 102 (e.g., a server, such as an application server), a web server 104, database 116, multiple customer mobile computing devices 110, 112, and operator mobile computing device 114 operatively coupled over communication network 108. Recommender computing device 102, web server 104 and multiple customer mobile computing devices 110, 112, and operator mobile computing device 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 108.

In some examples, recommender computing device 102 can be a computer, a workstation, a laptop, a server such as a cloud-based server, or any other suitable device. In some examples, each of multiple customer mobile computing devices 110, 112, and operator mobile computing device 114 can be a cellular phone, a smart phone, a tablet, a personal assistant device, a voice assistant device, a digital assistant, a laptop, a computer, or any other suitable device. In some examples, recommender computing device 102 is operated by a retailer, and multiple customer mobile computing devices 110, 112 are operated by customers of the retailer.

Although FIG. 1 illustrates two customer mobile computing devices 110, 112, search engine system 100 can include any number of customer mobile computing devices 110, 112. Similarly, search engine system 100 can include any number of recommender computing device 102, web server 104, and database 116.

In some examples, web server 104 hosts one or more web pages, such as a retailer's website. Web server 104 may transmit purchase data related to orders purchased on the website by customers to recommender computing device 102. Web server 104 may also transmit a search request to recommender computing device 102. The search request may identify a search query provided by a customer. The search query may include one or more search terms. In response to the search request, recommender computing device 102 may execute a machine learning model (e.g., algorithm) of a search engine to determine search results based on the one or more search terms included in the search query. The machine learning model may be any suitable machine learning model, such as one based on decision trees, linear regression, logistic regression, support-vector machine (SVM), K-Means, or a deep learning model such as a neural network. The machine learning model may execute with hyperparameters selected and tuned by recommender computing device 102, as described further below. Recommender computing device 102 may then transmit the search results to the web server 104. Web server 104 may display the search results on the website to the customer. For example, the search results may be displayed on a search results webpage in response to the search query entered by the customer.

First customer mobile computing device 110, and N^{th} mobile computing device 112 may communicate with web server 104 over communication network 108. For example, each of multiple mobile computing devices 110 and 112 may be operable to view, access, and interact with a website hosted by web server 104. In some examples, web server 104 hosts a website for a retailer that allows for the purchase of items. The website may further allow a customer to search for items on the website via, for example, a search bar. A customer operating one of multiple mobile computing devices 110, 112 may access the website and perform a search for items on the website by entering in one or more terms into the search bar. In response, the website may return search results identifying one or more items, as described above and further herein. In various implementations, the returned search results may include a graphical representation for each of the one or more items, and one or more interactive features that, when interacted with, triggers a one or more operations. For example, the interactive feature may enable the customer to add one or more of the items to an online shopping cart, and allow the customer to perform a “checkout” of the shopping cart to purchase the added items. In another example, the interactive feature may, when interacted with, cause the website to display additional information about the corresponding item. In other implementations, the graphical representations for each of the one or more items may be an interactive feature or have one or more interactive elements, that when interacted with, causes the website to display additional information regarding the corresponding items.

Recommender computing device 102 may enable the search engine system 100 to add or modify existing search terms to be included in an existing library or catalog of taxonomies for a search engine. In some implementations, recommender computing device 102 may output one or more keyword search term recommendations. The one or more keyword search term recommendations may include a recommendation to add a new search term to an existing taxonomy library or modify an existing search term in the existing taxonomy library (e.g., to add or remove a particular term or word from an existing keyword search term).

In some implementations, each keyword search term may be associated with a particular domain or category. For example, in an e-commerce context, each domain or category can be associated with a particular department of a particular e-commerce entity (e.g., toys). In other implementations, recommender computing device 102 may optimize the keyword search term additions and modifications for particular user or customer interactions between the customer and a website of an e-commerce entity. Examples of particular user or customer interactions, the recommender computing device 102 may be optimizing the keyword search term additions and modifications for, include, click-through interactions and add-to-cart interactions.

Recommender computing device 102 is further operable to communicate with database 116 over communication network 108. For example, recommender computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to recommender computing device 102, in some examples, database 116 can be a local storage device, such as a hard drive, a non-volatile memory, or a USB stick.

In some implementations, identified keyword search terms of search queries made by customers, and associated interactions of customers on an ecommerce platform, such as click-through or add-to-cart interactions, may be further stored in database 116. For example, a user inputted search query may cause a website of an e-commerce entity to display a set of search results. Each search result may be associated with a particular product. Additionally, a user may interact with their device to select a graphical feature of a particular search result to either add a corresponding product to cart or click-through to view additional information about the corresponding product. Database 116 may store such interactions that stemmed from the search query of the customer. Further, in other examples, database 116 may store product data of products of ecommerce entity that customer's interacted with on the ecommerce platform. Additionally, the product data may include product information of products of ecommerce entity, such as item title information.

In some implementations, database 116 stores and maintains a catalog or library of taxonomies. Additionally, database 116 may store the one or more machine learning models for a search engine. In some examples, authorized data-driven taxonomy recommendations (e.g., recommendations to add or modify particular taxonomy nodes or entries) generated by recommender computing device 102 can cause the taxonomy library or catalog stored in database 116 to be updated accordingly. That way, recommender computing device 102 can improve and optimize the performance of the search engine (e.g., to enable the search engine to be able to output relevant search results).

Communication network 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 108 can provide access to, for example, the Internet.

Operator mobile computing device 114 may execute a service application to communicate with recommender computing device 102, over communication network 108. Additionally, operator mobile computing device 114 may enable a user of operator mobile computing device 114 to communicate with recommender computing device 102 to modify or add new key word search terms to a taxonomy library or catalogue of a search engine. For example, recommender computing device 102 may communicate with the service application executing on operator mobile computing device 114 to output a keyword search term recommendation (to add or modify an existing keyword search term). If the operator mobile computing device 114 transmits a communication back to recommender computing device 102 indicating acceptance of the recommendation, recommender computing device 102 may update the taxonomy library or catalogue accordingly.

In some implementations, operator mobile computing device 114 may initiate the recommender computing device 102 to implement one or more keyword search term recommendation operations. For example, an operator of operator mobile computing device 114 may utilize the service application to select a particular domain. Recommender computing device 102 may obtain data indicating selection of the particular domain and in response to and based on the domain data, recommender computing device 102 may implement one or more keyword search term recommendation operations.

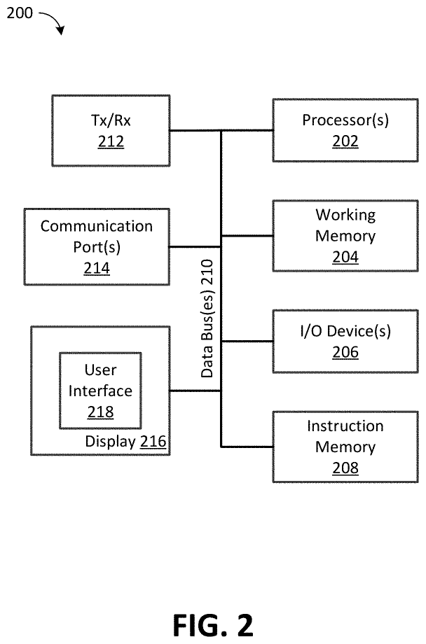

FIG. 2 illustrates a block diagram of example recommender computing device 102 of FIG. 1. Recommender computing device 102 can include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 202 can be configured to perform a certain function or operation by executing code, stored on instruction memory 208, embodying the function or operation. For example, processors 202 can be configured to execute code stored in instruction memory 208 to perform one or more of any function, method, or operation disclosed herein.

Additionally, processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of recommender computing device 102. Working memory 204 can be a random access memory (RAM) such as a static random access memory (SRAM) or dynamic random access memory (DRAM), or any other suitable memory.

Input/output devices 206 can include any suitable device that allows for data input or output. For example, input/output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as interaction data, product data, and/or keyword search data.

Display 216 can display user interface 218. User interface 218 can enable user interaction with recommender computing device 102. For example, user interface 218 can be a user interface for an application of a retailer that allows a customer to view and interact with a retailer's website. In some examples, a user can interact with user interface 218 by engaging input/output devices 206. In some examples, display 216 can be a touchscreen, where user interface 218 is displayed on the touchscreen.

Transceiver 212 allows for communication with a network, such as the communication network 108 of FIG. 1. For example, if communication network 108 of FIG. 1 is a cellular network, transceiver 212 is configured to allow communications with the cellular network. In some examples, transceiver 212 is selected based on the type of communication network 108 recommender computing device 102 will be operating in. Processor(s) 202 is operable to receive data from, or send data to, a network, such as communication network 108 of FIG. 1, via transceiver 212.

### Keyword Search Term Recommendation

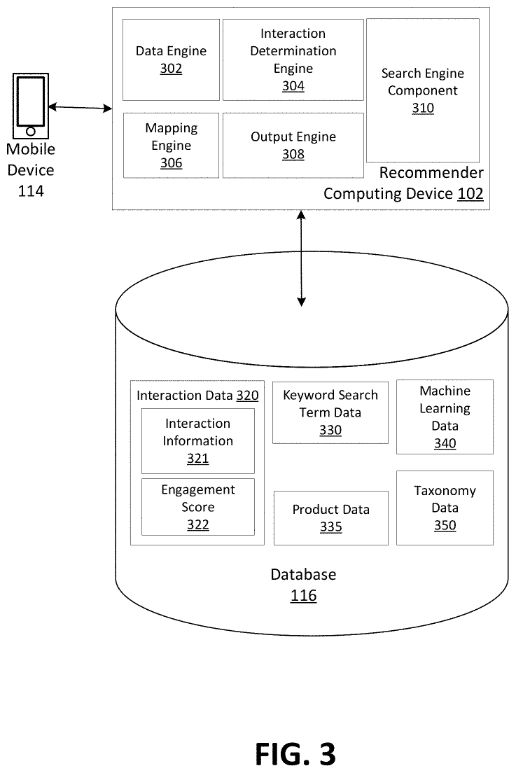

FIG. 3 is a block diagram illustrating examples of various portions of the recommender computing device 102. As illustrated in FIG. 3, recommender computing device 102 can include data engine 302, interaction determination engine 304, mapping engine 306, output engine 308 and search engine component 310. In some examples, one or more of data engine 302, interaction determination engine 304, mapping engine 306, output engine 308 and search engine component 310 may be implemented in hardware. In other examples, one or more of data engine 302, interaction determination engine 304, mapping engine 306, output engine 308 and search engine component 310 may be implemented as an executable program maintained in a tangible, non-transitory memory, such as instruction memory 208 of FIG. 2, that may be executed by one or processors, such as processor 202 of FIG. 2.

Additionally, in various implementations, database 116 of FIG. 3, may store interaction data 320, keyword search term data 330 and product data 335. In some examples, the keyword search term data 330 may indicate, keyword search terms provided by customers. Additionally, the keyword search term data 330 may indicate, for each keyword search term, an associated one or more domains or categories. In such examples, each domain of the one or more domains may be associated with a particular department of a particular ecommerce entity (e.g., toys).

In some implementations, keyword search term data 330 may be obtained from search requests transmitted by web server 104. For example, customer may access, from mobile computing device 110 and/or 112, one or more webpages hosted by web server 104. Upon accessing the one or more webpages the customer may utilize mobile computing device 110 and/or 112 to submit a search request. The search request may include a search query and the search query may indicate one or more keyword search terms and one or more domains or categories the search query may be conducted in. Web server 104 may transmit to data engine 302 search request data indicating search requests that customers submitted through the one or more webpages. Additionally, data engine 302 may process and parse through the search request to determine from the search query the one or more keyword search terms and associated one or more domains or categories. Moreover, data engine 302 may generate the keyword search term data 330 based on the determined one or more keyword search terms and associated one or more domains or categories, and transmit the keyword search term data 330 to database 116. In some examples, the keyword search term data 330 may associate a timestamp with each of the one or more keyword search terms. The timestamp may indicate the time and/or date the search query that included the keyword search term was submitted.

In some implementations, interaction data 320 may include interaction information 321. Interaction information 321 can include one or more interactions between customers and an ecommerce platform, such as a website. For example, for each search query of each customer, web server 104 may display search results on a website to the customer. The search results may include one or more products and be based on the search query provided by the customer. Additionally, web server 104 may record interactions of the customers with website elements (e.g., graphical representations of the one or more products, interactive/selection features associated with the one or more products, etc.) presented with the search results. Further, web server 104 may generate interaction information 321 of the interactions between the customer and the website, and transmit it to recommender computing device 102. In some examples, the interaction information 321 may include a timestamp with each of recorded interaction. The timestamp may indicate the time and/or date the interaction was recorded.

An example of a recorded interaction includes click-through interactions. For example, the search result displayed to the customer (via a mobile device of the customer, such as mobile computing device 110/112), may include a one or more products relevant to the search query, a graphical representation for each of the one or more products, and a selectable feature for each graphical representation. The selectable feature, when interacted with (e.g., click, or user input from a touch-screen) may cause the website to further display additional information of the corresponding product. Such an interaction may be recorded as a click through type interaction. Additionally, web server 104 may transmit data of the recorded interaction to recommender computing device 102. In some examples, the recorded interaction may also include additional data indicating the associated product of website elements the customer interacted with on the web site and/or the search query including keyword search terms that the search result with the associated product, is based on.

Another example of a recorded interaction includes add-to-cart interactions. For example, the search result displayed to the customer (via a mobile device of the customer, such as mobile computing device 110/112), may include a one or more products relevant to the search query, a graphical representation for each of the one or more products, and a selectable feature for each graphical representation. The selectable feature, when interacted with (e.g., click, or user input from a touch-screen) may cause the product to be added into a virtual cart. Such an interaction may be recorded as an add-to-cart type interaction. In some examples, the recorded interaction may also include additional data indicating the associated product of website elements the customer interacted with on the website and/or the search query including keyword search terms that the search result with the associated product, is based on.

In some implementations, database 116 may store product data 335. Product data 335 may indicate one or more products that were interacted with on the ecommerce platform. In some examples, the one or more products may be included in a search results stemming from a search queries provided by customers. Additionally, product data 335 may include product information of products that were interacted with on the e-commerce platform. Examples of product information include item title information (e.g., the product name) and what domain/category the product is associated with. In some examples, the item title information may but the full product name. In other examples, the item title information may be further processed to remove words relating to color and quantity. In yet other examples, the item title information may be further processed to only include the nouns in the item title. In some implementations, the product data 335 may include a timestamp with each of the one or more products that were interacted with on the ecommerce platform. The timestamp may indicate the time and/or date the product was interacted with. For example, the timestamp may indicate a time and/or date a particular product was clicked-through or added to cart.

In various implementations, database 116 may store taxonomy data 350. Taxonomy data 350 may include data of an existing taxonomy library or catalog or of a newly constructed taxonomy library or catalog. For example, the data of the existing taxonomy library or catalog may include keyword search terms. Additionally, database 116 may store machine learning data 340 identifying and characterizing one or more machine learning models. In various implementations, search engine component 310 may utilize taxonomy data 350 and machine learning model of machine learning data 340 to determine relevant search results in response to a search request obtained from web server 104.

In some implementations, recommender computing device 102 may utilize interaction data 320, keyword search term data 330 and product data 335 to construct and maintain a taxonomy library of a search engine system. For example, recommender computing device 102 may utilize interaction data 320, keyword search term data 330 and product data 335 to organize, define and/or modify taxonomy nodes or elements of the taxonomy library or catalog (e.g., taxonomy data 350). Additionally, recommender computing device 102 may implement one or more keyword search term recommendation operations when organizing, defining and/or modifying taxonomy data 350.

In some implementations, recommender computing device 102 may implement the one or more keyword search term recommendation operations in response to obtaining domain data. Domain data may be obtained from operator mobile computing device 114. For example, operator mobile computing device 114 may execute a service application to communicate with recommender computing device 102, over communication network 108. Additionally, operator mobile computing device 114 may enable a user of operator mobile computing device 114 to modify or add a new taxonomy node or element, such as a key word search term, to a taxonomy library or catalogue of a search engine. For example, operator of operator mobile computing device 114 may input domain data or provide an input including domain data specifying a particular category or domain to a service application executing on operator mobile computing device 114. The provided domain data may be transmitted to recommender computing device 102. Recommender computing device 102 may, in response to the obtained domain data, initiate the one or more keyword search term recommendation operations.

In some implementations, the one or more key word search recommendation operations may include identifying keyword search term data associated with the domain or category identified in the domain data. For example, based on the domain identified in the domain data, data engine 302 may identify, from the keyword search term data 330, a set of keyword search terms that are each associated with the domain identified in the domain data. For instance, an operator of operator mobile computing device 114 may input domain data indicating the “toy” domain. In response to receiving the domain data, data engine 302 may identify from keyword search term data 330, one or more keyword search terms associated with the domain, “toy.” In some implementations, data engine 302 may identify keyword search term data for a particular time interval. For example, operator of operator mobile computing device 114 may identify/select a particular domain on a particular date, such as Jan. 1, 2021. Data engine 302 may identify and retrieve keyword search term data associated with the identified/selected domain with timestamps within the last quarter or ninety days of the day the operator selected/identified a particular domain.

Additionally, the one or more key word search recommendation operations may include identifying product data 335 associated with the domain or category identified in the domain data. For example, based on the product information of product data 335, data engine 302 may determine product data 335 (e.g., one or more products that were interacted with on the ecommerce platform) that is associated with the identified domain. In some implementations, data engine 302 may identify product data 335 for a particular time interval. For example, data engine 302 may identify and retrieve product data 335 associated with the identified/selected domain with timestamps within the last quarter or ninety days of the time and/or date an operator of operator mobile computing device 114 selected/identified a particular domain.

Moreover, the one or more key word search recommendation operations may include identifying interaction data 320 associated with the domain or category identified in the domain data. For example, based on the identified keyword search terms that are associated with the domain identified from the domain data and the each of the one or more products that were interacted with and are associated with the domain identified from the domain data, data engine 302 may determine, from interaction data 320, one or more interactions stemming from each of the identified keyword search terms and products that were included in a search results based on the identified keyword search them. An example of an interaction of interaction data 320 include click-through interactions. For example, a customer may interact with an interactive feature of a graphical representation of a product that causes a website, the interactive feature and graphical representation are on, to display additional information related to the product. Another example of an interaction of interaction data 320 include add-to-cart interactions. For example, a customer may interact with a selectable feature of a graphical representation of a product that causes a website, the selectable feature and graphical representation are on, to add the product to a virtual cart.

In some implementations, data engine 302 may identify interaction data 320 for a particular time interval. For example, data engine 302 may identify and retrieve interaction data 320 associated with the identified/selected domain with timestamps within the last quarter or ninety days of the time and/or date an operator of operator mobile computing device 114 selected/identified a particular domain.

In some implementations, the one or more keyword search recommendation operations may further include, mapping each of the keyword search terms of a particular domain to a particular product that was interacted with (e.g., web elements of a product that were interacted with by a customer on an ecommerce platform) based on corresponding interactions that stem from a search result based on the keyword search terms, and products that are associated with the corresponding interactions. For example, mapping engine 306 may utilize the identified interactions to determining pairings between a particular keyword search term of the one or more identified keyword search terms and a particular product of one or more identified products (herein also described as a “keyword search term-product pairing”). In some examples, the identified interactions include recorded customer interactions with selectable feature associated with a particular product that was included in a search result based on a search query that includes the identified keyword search term. For example, a pairing between keyword search term “cards” and a particular card deck product may be linked by one or more interactions, such as click-through interactions and/or add-to-cart interactions. In examples where the recorded interaction is a click-through interaction, the customer interactions with the selectable feature may cause the website presenting the search results, to further display or present additional information about the particular card-deck product. In examples where the recorded interaction is an add-to-cart interaction, customer interactions with the selectable feature may cause the website to add the particular card-deck product to a virtual cart.

In various implementations, recommender computing device 102 may determine a rate of each type of interaction for each keyword search term-product pairing. In such implementations, each keyword search term-product pairing may have one or more associated interactions. Additionally, interaction determination engine 304 can determine a rate for each type of interaction that occurs between each keyword search term-product pairing. In some examples, interaction determination engine 304 can determine a rate of click-through interactions that occur between a particular keyword search term and product pairing. In other examples, interaction determination engine 304 can determine a rate of add-to-cart interactions that occur between a particular keyword search term and product pairing. In various examples, each keyword search term-product pairing can have more than one type of interaction associated with it. In such examples, interaction determination engine 304 can determine a rate for each type of interaction associated with such a keyword search term-product pairing.

In some implementations, the determined rate of each of the one or more interactions associated with a particular keyword search term-product pairing can be normalized and represented by an engagement score 322. In various implementations, the rate of each of the one or more interactions of a particular keyword search term-product pairing can be combined. The combined rate of interactions of a particular keyword search term-product may be normalized and represented as an engagement score 322. Database 116 can store engagement score 322 along with data indicating which keyword search-term-product pairing a particular engagement score 322 is associate to.

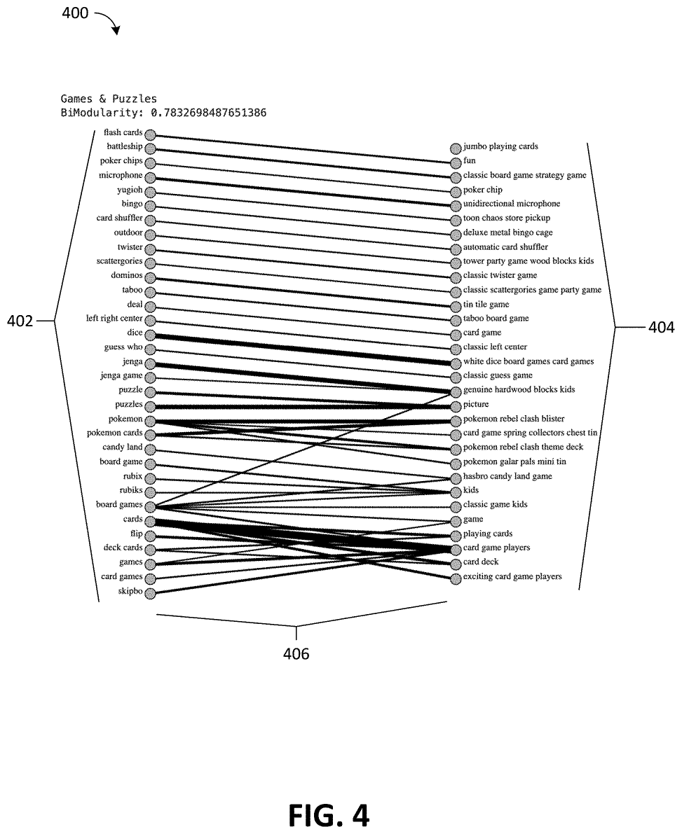

In some implementations, mapping engine 306 may utilize a bipartite graph to map each of the keyword search terms of a particular domain to particular products of the ecommerce entity based on corresponding interaction information. The corresponding interaction information may indicate one or more customer interactions of the particular product, and the keyword search term the search result with that particular product is based on. FIG. 4 illustrates an example bipartite graph. As illustrated in FIG. 4, the bipartite graph 400 is of a particular domain, “toys.” Additionally, bipartite graph 400 includes multiple keyword search term nodes 402. Each of the multiple keyword search term nodes 402 is associated with the domain “toys.” Bipartite graph 400 also includes multiple product nodes 404, which in this example are represented by corresponding nouns of the corresponding item title of the product. In various implementations, each of the multiple product nodes 404 may be represented by the full item title of the respective product. Further, each of the multiple keyword search term nodes 402 may be paired with or linked to one or more product nodes 404 by edge 406.

Each edge 406 can be based on interaction data (e.g., interaction data 320) of one or more interactions associated with each keyword search term of a particular keyword search term node 402 and product node 404 pairing. For example, the “skipbo” keyword search term node 402 and “card game players” product node 404 are linked by an edge 406 based on click-through interaction data and/or add-to-cart interaction data.

In some implementations, each edge 406 may be weighted and represent the rate of the one or more interactions (e.g., click-through interactions and/or add-to-cart interactions) associated with each keyword search term of a particular keyword search term node 402 and product node 404 pairing. As illustrated in FIG. 4, the weight of each edge 406 may be represented by the thickness of the edge 406 (e.g., the thicker the edge, the greater the value/rate of the one or more interactions associated with each keyword search term of a particular keyword search term node 402 and product node 404 pairing). In various implementations, the weight of each edge 406 may be further represented by an engagement score (e.g., engagement score 322).

Additionally, the one or more keyword search term recommendation operations may further include determining, one or more clusters of keyword search terms based on the keyword search term-product pairings. For example, mapping engine 306 may determine one or more clusters of keyword search terms by identifying one or more keyword search terms that are paired or linked to each product. For instance, as illustrated in FIG. 4, mapping engine 306 may determine that a cluster keyword search terms for a particular product represented by “card game players” product node 404 may include “board games” keyword search term node 402, “cards” keyword search term node 402, “flip” keyword search term node 402, “games” keyword search term node 402, “card games” keyword search term node 402, and “skipo” keyword search term node 402.

In some implementations, mapping engine 306 may utilize modularity optimization to detect and determine keyword search term clusters. In some examples, mapping engine 306 may utilize Louvain parameter optimization or algorithm to detect and determine the keyword search term clusters. In such examples, mapping engine 306 may detect and determine the keyword search term clusters by determining the difference between the actual number of edges between nodes v and w and the expected number of edges between them, as in accordance with the following equation:

$${A}_{vw} - \frac{kvkw}{2 m} \qquad ( eq . 1 )$$

where:
   the Actual number of edges between nodes v and w=A_{vw};
   the expected number of edges between nodes v and

$$w = \frac{kvkw}{2 m} ; \qquad ( eq . 2 )$$

keyword search term node 402=v;
   product node 404=w; and
   node degrees kv and kw, and the total number of stubs in the network can be calculated according to the following equation:

l=Σku=2m. (eq. 3)

Additionally, mapping engine 306 may sum over all node pairs according to the equation:

$$Q = \frac{1}{2 m} \sum [ Avw - \frac{kvkw}{2 m} ] \partial ( Ci , Cj ) \qquad ( eq . 4 )$$

where:
   Ci, Cⱼ are communities of the nodes; and
   ∂(Ci, Cj) is Kronecker Delta Function (∂(x, y)=1 if x=y, 0 otherwise)

Furthermore, the one or more keyword search term recommendation operations may also include, determining a representative keyword search term for each determined cluster of keyword search terms. For example, for each cluster of keyword search terms, mapping engine 306 may determine a representative keyword search term, based on the engagement score 322 of each keyword search term-product pairing within each cluster. In some examples, mapping engine 306 may determine a representative keyword search term is based on the keyword search term-product pair with the highest associated engagement score 322. For instance, as illustrated in FIG. 4, mapping engine 306 may determine that a cluster of keyword search terms for a particular product represented by “card game players” product node 404 may include “board games” keyword search term node 402, “cards” keyword search term node 402, “flip” keyword search term node 402, “games” keyword search term node 402, “card games” keyword search term node 402, and “skipo” keyword search term node 402. Additionally, mapping engine 306 may determine that the “cards” keyword search term node 402 and “card game players” product node 404 pair has the highest associated engagement score 322 (as represented by the thickest edge 406). As such, mapping engine 306 may determine that “cards” may be the representative keyword search term for that cluster.

In some other example, mapping engine 306 may utilize term frequency-inverse document frequency (TF-IDF) like process to determine a representative keyword search term for each determined cluster of keyword search terms. In such implementations, mapping engine 306 may treat each cluster as a document's corpus and each keyword in the community as a document. Additionally, mapping engine 306 may extract keywords using TF-IDF ranking for unigrams, bigrams, and trigram keywords from the determined clusters of keyword search terms. That way, mapping engine 306 may detect a keyword search term medoid that is based on cosine distances to determine the most relevant or representative keyword search term for each cluster of keyword search terms. As described herein, a keyword search term medoid is defined as the keyword search term in the cluster whose average dissimilarity to all the other objects in the community is minimal, or most centrally located point in the corresponding cluster.

In some implementations, mapping engine 306 may utilize a TextRank type algorithm along with the TF-IDF like process to determine a representative keyword search term for each determined cluster of keyword search terms. For example, mapping engine 306 may utilize the TextRank type algorithm and treat each keyword search term in each cluster as a text document to determine the relevance of each keyword search term in each cluster. The TextRank algorithm is based on a graph where each node is a word of a text document and the edges are constructed by observing the co-occurrence of words inside a moving window of a predefined size. A node's rank is computed using an algorithm similar to a PageRank algorithm, where the TextRank treats text documents as websites. The PageRank algorithm ranks websites in search engine results. The number and quality of links to a page are factors in determining the rank of the web site—the greater the number and/or quality of links to a web site, the greater the rank. As such, with regards to keyword search terms in each cluster, the higher the engagement store of a keyword search term of a cluster, the higher the rank or relevance of the particular keyword search term for each cluster. In various implementations, mapping engine 306 may apply the TextRank type algorithm to each cluster after the application of the TF-IDF type process.

Determined representative keyword search terms may be presented to an operator of operator mobile computing device 114. In some implementations, output engine 308 may output representative keyword search terms for each determined cluster. In some implementations, output engine 308 may determine whether the determined representative keyword search terms are already included in the existing taxonomy library. In such implementations, output engine 308 can compare the keyword search terms of an existing taxonomy library or catalog against the determined representative keyword search terms, based on the taxonomy data 350. In examples where the output engine 308 determines that one or more of the determined representative keyword search terms match any of the keyword search terms of an existing taxonomy library, output engine 308 may not cause a service application executing on operator mobile computing device 114 to output the matched determined representative keyword search terms.

In examples where the output engine 308 determines that one or more of the determined representative keyword search terms do not match any of the keyword search terms of an existing taxonomy library, output engine 308 may cause a service application executing on operator mobile computing device 114 to output the determined representative keyword search terms that did not match with any of the keyword search terms of an existing taxonomy library. In some examples, output engine 308 may transmit an instruction to the service application executing on operator mobile computing device 114 to generate a notification that indicates that there are one or more new representative keyword search terms to be added to the taxonomy library of the search engine system. Additionally, or alternatively, the notification may indicate that there are one or more keyword search terms to be modified in the taxonomy library of the search engine system and/or corresponding modification(s) (e.g., addition or removal of an element or word from an existing keyword search term of taxonomy data 350). In such examples, the notification can include one or more interactive features.

In some examples, the interactive feature can cause the service application to transmit an instruction to recommender computing device 102 to update the taxonomy data 350 according to the notification. For example, for a notification that indicates the addition of one or more new keyword search terms to taxonomy data 350, the instruction can cause recommender computing device 102 to add the one or more new keyword search terms to taxonomy data 350. In another example, for a notification that indicates modifications to one or more keyword search terms in taxonomy data 350, the instruction can cause recommender computing device 102 to modify the one or more keyword search terms to taxonomy data 350 (e.g., addition or removal of an element or word from an existing keyword search term of taxonomy data 350).

In other examples, the output engine 308 may transmit an instruction to the service application executing on operator mobile computing device 114 to utilize a typeahead feature to generate the new representative keyword search terms. In such examples, an operator may confirm addition of the new representative keyword search term by selecting the new representative keyword search term, or selecting an interactive feature confirming addition of the new representative keyword search term. Additionally, the service application executing on operator mobile computing device 114 may transmit an instruction to recommender computing device 102 to add the new representative keyword search term to taxonomy data 350.

### Methodology

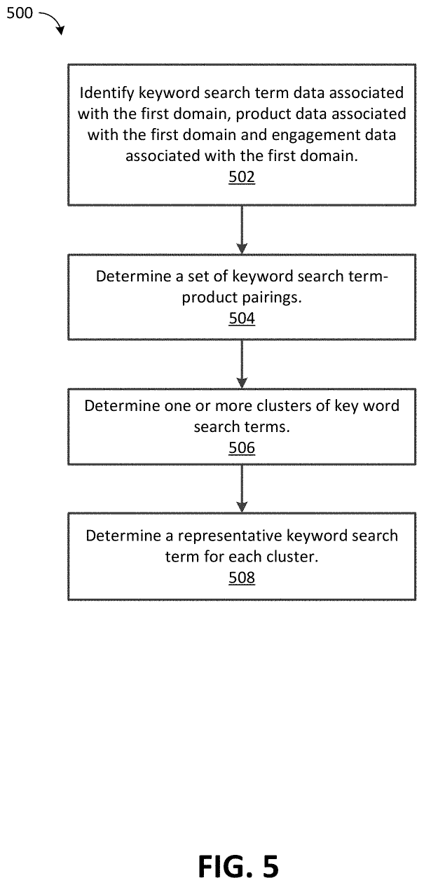

FIG. 5 illustrates an example method that can be carried out by the recommender computing device 102. In describing an example method of FIG. 5, reference is made to elements of FIGS. 1, 3 and 4 for purpose of illustrating a suitable component for performing a step or sub-step being described.

With reference to example method 500 of FIG. 5, recommender computing device 102 may identify keyword search term data 330 associated with the first domain, product data 335 associated with the first domain, and interaction data 320 associated with the first domain (502). In some implementations, operator of an operator mobile computing device 114 may provide domain data identifying a particular domain, such as a first domain. Additionally, data engine 302 may identify and obtain keyword search term data 330 associated with the first domain, product data 335 associated with the first domain, and interaction data 320 associated with the first domain, based on the domain data.

In some examples, the keyword search term data 330 may indicate a set of keyword search terms associated with the first domain. Additionally, the product data 335 may indicate one or more products one or more users engaged with via a user interface. Moreover, the interaction data 320 may indicate for each interaction, a particular interaction stemming from a keyword search term and a product that was included in a search result based on the keyword search term.

In some examples, recommender computing device 102 may determine a set of keyword search term-product pairings (504). In some implementations, mapping engine 306 may utilize identified interactions of interaction data 320 associated with the identified/selected domain to determining pairings between a particular keyword search term of the one or more identified keyword search terms and a particular product of one or more identified products.

In various implementations, interaction determination engine 304 can determine a rate for each type of interaction that occurs between each keyword search term-product pairing. In some examples, interaction determination engine 304 can determine a rate of click-through interactions that occur between a particular keyword search term and product pairing. In other examples, interaction determination engine 304 can determine a rate of add-to-cart interactions that occur between a particular keyword search term and product pairing. In various examples, each keyword search term-product pairing can have more than one type of interaction associated with it. In such examples, interaction determination engine 304 can determine a rate for each interaction associated with such a keyword search term-product pairing.

In other implementations, the determined rate of each of the one or more interactions associated with a particular keyword search term-product pairing can be normalized and represented by an engagement score 322. In various implementations, the rate of each of the one or more interactions of a particular keyword search term-product pairing can be combined. The combined rate of interactions of a particular keyword search term-product may be normalized and represented as an engagement score 322.

In some examples, recommender computing device 102 may determine one or more clusters of keyword search terms (506). For example, mapping engine 306 may determine a cluster keyword search terms by identifying one or more keyword search terms that are paired or linked to each product. Additionally, recommender computing device 102 may determine a representative keyword search term for each of the one or more clusters of keyword search terms (508).

In some examples, the recommender computing device 102 may output the representative keyword search term of each of the one or more clusters of keyword search terms (510). For example, output engine 308 may output representative keyword search terms for each determined cluster. In some implementations, output engine 308 may determine whether the determined representative keyword search terms are already included in the existing taxonomy library.

For instance, output engine 308 can compare the keyword search terms of an existing taxonomy library or catalog against the determined representative keyword search terms, based on the taxonomy data 350. If output engine 308 determines that one or more of the determined representative keyword search terms match any of the keyword search terms of an existing taxonomy library, output engine 308 may not cause a service application executing on operator mobile computing device 114 to output the matched determined representative keyword search terms. However, if output engine 308 determines that one or more of the determined representative keyword search terms do not match any of the keyword search terms of an existing taxonomy library, output engine 308 may cause a service application executing on operator mobile computing device 114 to output the matched determined representative keyword search terms. In some examples, output engine 308 may transmit an instruction to the service application executing on operator mobile computing device 114 to generate a notification that there are new representative keyword search terms that can be added to the taxonomy library of the search engine system. In other examples, the output engine 308 may transmit an instruction to the service application executing on operator mobile computing device 114 to utilize a typeahead feature to generate the new representative keyword search terms.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
one or more processors;
a set of memory resources to store a set of instructions that when executed by the one or more processors cause the system to:
obtain domain data, the domain data indicating a first domain;
based on the obtained domain data, implement operations that generate a representative keyword search term, the operations including:
based on the domain data, identifying keyword search term data associated with the first domain, product data associated with the first domain, and interaction data associated with the first domain; based on the keyword search term data, the product data and the interaction data, determining a set of keyword search term-product pairings;
based on the set of keyword search term-product pairings and an engagement score associated with each keyword search term-product pairing of the set of keyword search term-product pairings, determining one or more clusters of keyword search terms; and
based on the engagement score associated with each keyword search term of each of the one or more clusters, determining, for each of the one or more clusters of keyword search terms, the representative keyword search term.

2. The system of claim 1, wherein:
the keyword search term data identifies and characterizes a set of keyword search terms associated with the first domain;
the product data identifies and characterizes one or more products one or more users engaged with via a user interface; and
the interaction data identifies and characterizes, for each interaction, a particular interaction stemming from a keyword search term and a product that was included in a search results based on the keyword search term.

3. The system of claim 1, wherein the operations further include:
determining, for each keyword search term-product paring of the set of keyword search term-product pairings, the engagement score.

4. The system of claim 1, wherein each of the one or more clusters of keyword search terms includes one or more keyword search terms of a set of keyword search terms that are associated with a particular product of one or more products.

5. The system of claim 1, wherein the one or more processors execute the set of instructions to further cause the system to:
output the representative keyword search term of each of the one or more clusters of keyword search terms.

6. The system of claim 5, wherein the one or more processors execute the set of instructions to further cause the system to:
receive, from a service application executing on an operator mobile computing device, input data, wherein obtaining the domain data is based in part on the input data.

7. The system of claim 6, wherein outputting the representative keyword search term of each of the one or more clusters of keyword search terms includes:
in response to receiving the input data, transmitting, to the service application executing on the operator mobile computing device, a first dataset identifying and characterizing the representative keyword search term of each of the one or more clusters, the first dataset causing an interface presented by the service application to display the representative keyword search term of each of the one or more clusters.

8. The system of claim 5, wherein the operations further include:
determining whether at least a first representative keyword search term of a first cluster of the one or more clusters matches any existing keyword search terms of a library of taxonomies stored in a database.

9. The system of claim 8, wherein the one or more processors execute the set of instructions to further cause the system to output at least the first representative keyword search term in response to determining at least the first representative keyword search term does not match any of the existing keyword search terms of the library of taxonomies.

10. The system of claim 1, wherein the one or more processors execute the set of instructions to cause the system to determine the one or more clusters of keyword search terms by utilizing a bipartite graph.

11. A computer-implemented method comprising:
obtaining, by a processor of a system, domain data, the domain data indicating a first domain;
based on the obtained domain data, implementing, by the processor, operations that generate a representative keyword search term, the operations including:
based on the domain data, identifying, by the processor, keyword search term data associated with the first domain, product data associated with the first domain, and interaction data associated with the first domain;
based on the keyword search term data, the product data and the interaction data, determining, by the processor, a set of keyword search term-product pairings;
based on the set of keyword search term-product pairings and an engagement score associated with each keyword search term-product pairing of the set of keyword search term-product pairings, determining, by the processor, one or more clusters of keyword search terms; and
based on the engagement score associated with each keyword search term of each of the one or more clusters, determining, by the processor and for each of the one or more clusters of keyword search terms, the representative keyword search term.

12. The computer-implemented method of claim 11, wherein:
the keyword search term data identifies and characterizes a set of keyword search terms associated with the first domain;
the product data identifies and characterizes one or more products one or more users engaged with via a user interface; and
the interaction data identifies and characterizes, for each interaction, a particular interaction stemming from a keyword search term and a product that was included in a search results based on the keyword search term.

13. The computer-implemented method of claim 11, wherein the operations further include:
determining, for each keyword search term-product paring of the set of keyword search term-product pairings, the engagement score.

14. The computer-implemented method of claim 11, wherein each of the one or more clusters of keyword search terms includes one or more keyword search terms of a set of keyword search terms that are associated with a particular product of one or more products.

15. The computer-implemented method of claim 11, further comprising:
outputting the representative keyword search term of each of the one or more clusters of keyword search terms.

16. The computer-implemented method of claim 15, further comprising:
receiving, from a service application executing on an operator mobile computing device, input data, wherein obtaining the domain data is based in part on the input data.

17. The computer-implemented method of claim 16, wherein outputting the representative keyword search term of each of the one or more clusters of keyword search terms includes:
in response to receiving the input data, transmitting, to the service application executing on the operator mobile computing device, a first dataset identifying and characterizing the representative keyword search term of each of the one or more clusters, the first dataset causing an interface presented by the service application to display the representative keyword search term of each of the one or more clusters.

18. The computer-implemented method of claim 15, wherein the operations further includes:
determining whether at least a first representative keyword search term of a first cluster of the one or more clusters matches any existing keyword search terms of a library of taxonomies stored in a database.

19. The computer-implemented method of claim 18, wherein outputting at least the first representative keyword search term is in response to determining at least the first representative keyword search term does not match any of the existing keyword search terms of the library of taxonomies.

20. A non-transitory computer readable medium having instructions stored thereon, wherein the instructions, when executed by one or more processors, cause a system to:
obtain domain data, the domain data indicating a first domain;
based on the obtained domain data, implement operations that generate a representative keyword search term, the operations including:
based on the domain data, identifying keyword search term data associated with the first domain, product data associated with the first domain, and interaction data associated with the first domain;
based on the keyword search term data, the product data and the interaction data, determining a set of keyword search term-product pairings;
based on the set of keyword search term-product pairings and an engagement score associated with each keyword search term-product pairing of the set of keyword search term-product pairings, determining one or more clusters of keyword search terms;
based on the engagement score associated with each keyword search term of each of the one or more clusters, determining, for each of the one or more clusters cluster of keyword search terms, the representative keyword search term.
